(19) United States
(12) Patent Application Publication
(10) Pub. No.: US 2023/0332003 A1
(43) Pub. Date: Oct. 19, 2023

(54) LOW-K AND LOW DIELECTRIC LOSS DIELECTRIC COMPOSITION FOR AEROSOL JET PRINTING

(71) Applicants: Raytheon Company, Waltham, MA (US); The University of Massachusetts, Lowell, MA (US)

(72) Inventors: Yuri Piro, Boston, MA (US); Susan C. Trulli, Lexington, MA (US); Craig Alfred Armiento, Acton, MA (US); Christopher R. Areias, Lawrence, MA (US); Alkim Akyurtlu, Arlington, MA (US); James Reuther, Merrimack, NH (US)

(21) Appl. No.: 18/134,785

(22) Filed: Apr. 14, 2023

Related U.S. Application Data
(60) Provisional application No. 63/330,806, filed on Apr. 14, 2022.

(51) Int. Cl. C09D 11/101; C09D 11/03; C09D 11/108; B41M 7/00

(52) U.S. Cl. CPC C09D 11/101; C09D 11/03; C09D 11/108; B41M 7/009

(57) ABSTRACT

A printable dielectric ink composition includes an inhibited catalyst-polymer complex and a crosslinker, wherein the printable dielectric ink composition has a viscosity of about 1 to about 10 cP.

### CROSS REFERENCE TO RELATED APPLICATIONS

This application claims the benefit of an earlier filing date from U.S. Provisional Application Ser. No. 63/330,806 filed Apr. 14, 2022, the entire disclosure of which is incorporated herein by reference.

### BACKGROUND

The present disclosure relates to additive manufacturing, and more specifically, to low-k and low dielectric loss dielectric compositions for aerosol jet printing.

Additive manufacturing (AM) has opened new avenues for electronic device assembly and prototyping. In conventional manufacturing, the same equipment used to manufacture the final part is also used to generate the prototype. However, such practices result in bottlenecks, where small changes in part design during the prototyping phase necessitate lengthy tooling and setup reconfigurations.

In contract, AM techniques remove the bottlenecks and facilitate rapid, iterative approaches to prototyping whereby corrections in the prototype architectures can be implemented and tested within short amounts of time. For AM prototyping to be effective, however, the materials used in fabrication must exhibit similar performance to the materials used in large format manufacturing processes.

Direct write is a powerful technique within the AM space that has demonstrated the ability to rapidly prototype electrical devices with high degrees of complexity. To fabricate a layered electrical device using a direct write printer, both conductive and dielectric inks are required. While conductive inks have received a great deal of research interest, and meaningful advances have been made to improve resolution, conductivity, and mechanical performance, printable dielectric materials have received far less attention.

### SUMMARY

According to one or more embodiments, a printable dielectric ink composition includes an inhibited catalyst-polymer complex and a crosslinker, wherein the printable dielectric ink composition has a viscosity of about 1 to about 10 cP.

According to other embodiments, a method of making the printable dielectric ink composition includes combining a monomer with catalyst for a period of time to form monomer-catalyst complex and initiate polymerization and form a catalyst-polymer complex. The method may optionally further include adding an inhibitor to the catalyst-polymer complex to inhibit the catalyst and polymerization, and form an inhibited catalyst-polymer complex. The method also includes adding a crosslinker to the catalyst-polymer complex to form a printable composition. The method includes printing the printable composition, and optionally activating the crosslinker, to form a crosslinked material on a substrate.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a flow diagram illustrating a method of making and using a dielectric ink according to embodiments;

FIG. 2 is a schematic diagram of a printing device for printing dielectric inks according to embodiments;

FIG. 3 is a schematic diagram of a printing device for printing dielectric inks according to embodiments;

FIG. 4A is a graph illustrating dielectric losses of dielectric inks; and

FIG. 4B is a graph illustrating dielectric constants of dielectric inks.

### DETAILED DESCRIPTION

Commercially available dielectric inks used in direct write systems suffer from two challenges. The first challenge relates to dielectric performance. The dielectric materials used in direct write printers are often photopolymers, which exhibit high degrees of dielectric loss at RF and microwave frequencies. The dielectric loss of these materials is attributed to the large dipole characteristic of vinyl ether, epoxy, or acrylate functionalities. To mitigate the losses, nonpolar polymers are required. Nonpolar polymers, however, cannot be fabricated with the same robust radical or cationic based photopolymerization reactions that work so well for vinyl ethers, epoxies, and acrylates. For this reason, nonpolar polymer compositions are often used as dispersions of preformed polymers in nonpolar solvents.

Using such dispersions of performed polymers in nonpolar solvents amounts to a second challenge. While it is possible to make a dispensable dielectric material based off preformed nonpolar polymers and associated solvents, the resulting mixture will include a large solvent fraction to facilitate dispensability. As a result, during the processing of the solvent-based material, the film will ultimately shrink in size and expel toxic nonpolar volatile organic compounds (VOCs).

Due to the foregoing challenges, when a high frequency device is prototyped with direct write techniques, the resulting device performance is either misaligned from what would have been achieved using conventional manufacturing procedures, or the printing process demands a degree of complexity and control that discourages large format adoption. To solve these inefficiencies, solvent-free techniques are needed for forming non-polar polymers in-situ. For such a technique to be adopted into real world industrial applications, these techniques must progress with a reaction mechanism that is tolerant to common manufacturing conditions such as oxygen and moisture, while also exhibiting a pot life that enables stable printing for prolonged periods of time.

Accordingly, described herein are solvent-free, low-k, low loss reactive dielectric ink compositions specifically engineered, in some aspects, for aerosol jet high frequency device fabrication. In particular, latent organometallic ring opening metathesis reactions, combined with either photoinduced thiol-ene crosslinking or increased monomer reactivity, are used and address the above challenges of solvent-free techniques. The inks can be aerosolized, printed, and rapidly cured into an ultra-low polarity film with high resolution on command. The viscosity of the inks can be tailored for use in different dispensing equipment. Further, the inks are engineered for use in open air environments, which lends itself to large format adoption, and the thermomechanical and dielectric capabilities of the inks can be integrated into RF and microwave device builds.

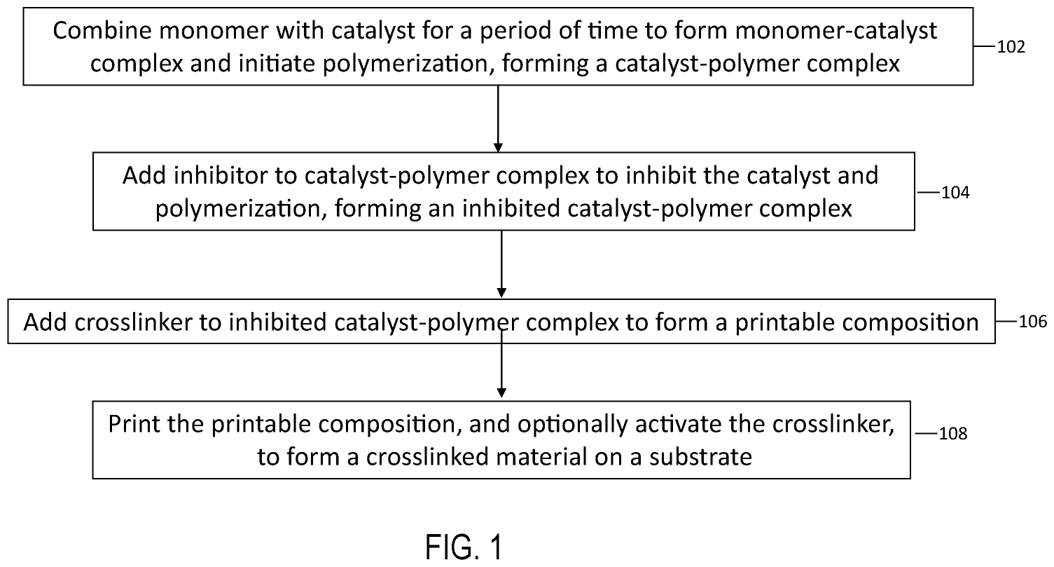

FIG. 1 is a flow diagram illustrating a method of making and using a dielectric ink according to embodiments. As shown in box 102, the method includes combining a monomer with catalyst for a period of time to form monomer-catalyst complex and initiate polymerization, forming a catalyst-polymer complex.

The monomer has a low viscosity. In one or more embodiments, the viscosity of the monomer is about 1 to about 10 centipoises (cP).

In some embodiments, the monomer incudes a strained bicyclic carbon ring, with an unsaturated bond within the ring. In other embodiments, the monomer includes an alkene group (e.g., a primary alkene group) pendant to a bicyclic ring. The pendant alkene group is in the exo conformation, the endo conformation, or both. A non-limiting example of the monomer includes 5-vinyl-2-norbornene.

The catalyst has an affinity for the monomer and is selected based on the type of monomer and the suitability for catalyzing olefin metathesis. Non-limiting examples of the catalyst include transition metal carbene complexes, e.g., ruthenium carbene complexes or Grubbs catalysts, including a first generation Grubbs catalyst (I) and a second generation Grubbs catalyst (II).

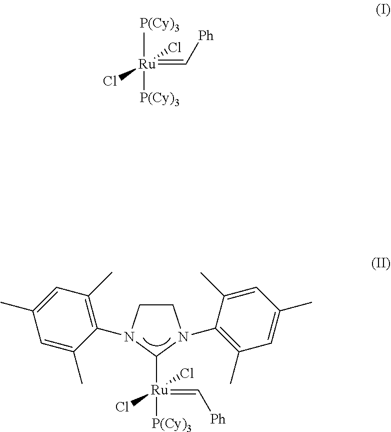

The catalyst forms a complex with the monomer and initiates polymerization and propagation. The monomer and catalyst are combined and incubated for a period of time that is sufficient to propagate the polymer to the desired viscosity. In one or more embodiments, the period of time is about 1 hour to about 10 hours. In other embodiments, the period of time is about 2 to about 8 hours, or 3 to about 6 hours.

The polymer propagation is continued until reaching a target viscosity and/or desired number of monomers (n). In one or more embodiments, the number of monomers (n) in the polymer is about 5 to about 10,000. In other embodiments, the number of monomers (n) is about 5 to about 1,000.

In one or more embodiments, the target viscosity is about 5 to about 2000 mPa·s. In other embodiments, the target viscosity is about 10 to about 100 mPa·s.

As shown in box 104, once reaching the desired viscosity and/or number of monomers, the method can optionally include adding an inhibitor to the catalyst-polymer complex to inhibit the catalyst and polymerization, forming an inhibited catalyst-polymer complex. The inhibitor is a compound that coordinates with the catalyst, rendering the catalyst inactive.

In one or more embodiments, the catalyst is a transition metal carbene complex, e.g., ruthenium carbene complex or Grubbs catalyst, and the inhibitor is a phosphite containing compound, which complexes with the transition metal in the catalyst to inactivate the catalyst is a reversible inhibitor that can be driven off (i.e., un-complexed) from the transition metal of the catalyst, by heating. Non-limiting examples of phosphite compounds include phosphites with methyl, ethyl, and propyl substituents, in any combination. For example, in one or more embodiments, the phosphite compound is trimethyl phosphite, triethyl phosphite, or tripropyl phosphite.

In some embodiments, the tri-alkyl phosphate inhibitors can be omitted and thus, step 104 can be omitted. In such a case reliance can be made on the vinyl pendant group of 5-vinyl-2-norbornene. This group slows viscosity drift by opening an alternate cross-metathesis reaction pathway to compete with the ring opening metathesis (ROMP). An example of the process is shown below:

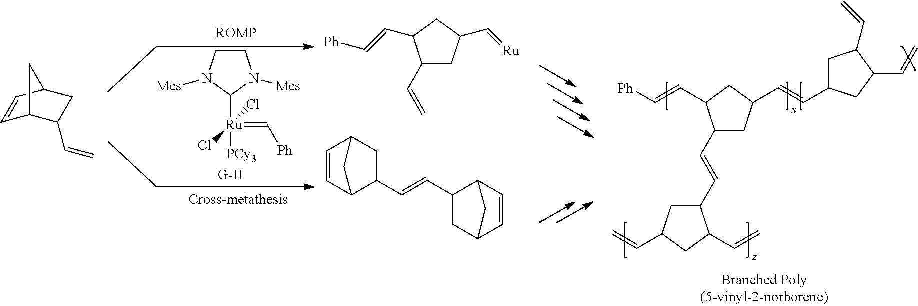

As shown in box 106, the method includes then adding a crosslinker to the inhibited catalyst-polymer complex to form a printable composition. The crosslinker is one or more compounds that will cause the printable composition to crosslink and form a crosslinked material on a substrate when printed using an additive manufacturing device, such as an aerosol jet printer.

The crosslinker is a composition of one or more compounds. The crosslinker includes at least one compound that bonds with the inhibited catalyst-polymer complex and forms crosslinks in the polymer. Crosslinking increases the viscosity of the polymer, as well as the modulus and thermal stability of the final cured material.

In one or more embodiments, the crosslinker includes a dithiol compound. In other embodiments, the crosslinker includes a diothiol compound and a photosensitizer, which allows for light activation. Non-limiting examples of the dithiol include 1,2-dithiol; 1,3-dithiol; 1,4-dithiol; 1,5-dithiol; 1,6-dithiol; 1,7-dithiol; 1,8-dithiol; 1,9-dithiol; 1,10-dithiol; 1,11-dithiol; 1,12-dithiol; 1,13-dithiol; 1,14-dithiol; 1,15-dithiol; 1,16-dithiol; 1,17-dithiol; 1,18-dithiol; 1,19-dithiol; and 1,20-dithiol.

The photosensitizer is a photosensitizing compound that is excited by light of a desired wavelength. In some embodiments, the photosensitizer is excited by ultraviolet light with a wavelength of about 200 to about 400 nanometers. Non-limiting examples of the photosensitizer include isopropylthioxanthone or benzophenone.

In one or more embodiments, the photosensitizer in the printing composition is excited by light, such as ultraviolet light, while being printed on a substrate. The excited photosensitizer abstracts a radical from a compound in the crosslinker, which forms a radical crosslinker that scavenges for and bonds with unsaturated bonds, such as unsaturated alkenes, in the polymer of the inhibited catalyst-polymer complex.

In some embodiments, light having a wavelength of about 200 to about 400 nanometers (nm) is applied to activate the crosslinker, and optionally, the photosensitizer when present, to induce crosslinking in the polymer. In other embodiments, the light has a wavelength of about or in any range between about 200, 250, 300, 350, and 400 nm. In such methods, a light source applies light to the printable composition during or subsequent to being deposited onto a surface of a substrate. Non-limiting examples of the light source includes light emitting diodes (LEDs).

In one or more embodiments, the crosslinker is activated by heat, and following addition of heat, the crosslinker induces crosslinking in the polymer. In some embodiments, heat is applied by depositing the printable composition onto a heated substrate. The temperature of the heated substrate is about 60 degrees Celsius to about 120 degrees Celsius in embodiments. In other embodiments, the temperature of the heated substrate is about 60 degrees Celsius to about 90 degrees Celsius. Further, a secondary heat treatment of 140 C for 8 hours may the mechanical performance of the film.

As shown in box 108, the method further includes printing the printable composition, and optionally activating the crosslinker, to form a crosslinked material on a substrate. The printing is performed by an additive manufacturing (AM) device or printer, for example, an aerosol jet printer.

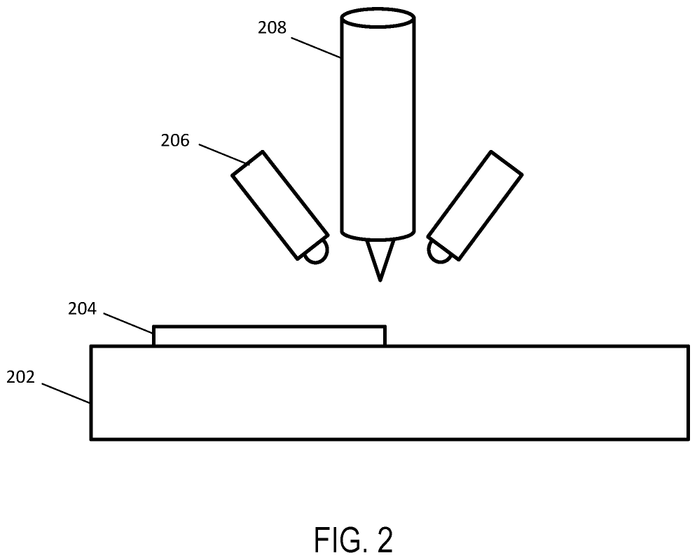

In embodiments in which an aerosol jet printer is used to print the printable composition, the printable composition is atomized or aerosolized into droplets, which is deposited onto a surface of a substrate, as shown in FIG. 2, which illustrates a schematic diagram of a printing device for printing dielectric inks according to embodiments. The deposition head 208 of the printing device deposits the printable composition onto a surface of a substrate 202. The printable composition is cured by one or more methods, which induces crosslinking in the printed composition, to form a cured layer of material 204 on the substrate 202.

The printable composition is cured by, for example, applying heat, light, or a both heat and light. In the embodiment shown in FIG. 2, one or more light sources 206, e.g., LED lamps, apply light onto the printable composition deposited on the substrate 202. The printable composition is also cured, optionally, by the printed layer of material 204 by heating the substrate 202.

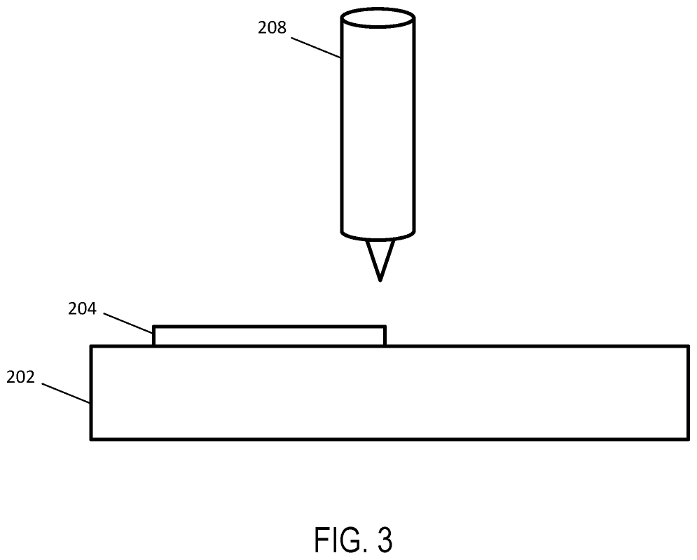

FIG. 3 is a schematic diagram of a printing device for printing dielectric inks according to embodiments. The printable composition is cured by heat, without applying light, by depositing the printable composition onto the surface of a heated substrate 202 to form the cured layer of material 204.

The dielectric printable composition described herein is formed by deactivating and subsequently reactivating a catalyst bound to a polymer chain, which provides a composition that can be cured by either mild heating, light activation, or a combination thereof. Print line resolution is improved by optionally employing a light activated crosslinking mechanism and adding monomers with higher reactivity.

The dielectric ink compositions are free of or substantially free of a solvent. In one or more embodiments, the dielectric ink compositions include 0 weight % solvent. In other embodiments, the dielectric ink compositions include less than 10, 9, 8, 7, 6, 5, 4, 3, 2, or 1 weight % solvent.

In some embodiments, the cured dielectric materials have a dielectric constant of about 2.2 to about 3.0. In other embodiments, the cured dielectric materials have a dielectric constant of about 2.2 to about 2.5.

In one or more embodiments, the cured dielectric materials have a dielectric loss between 8.2 and 12.4 GHz of about 0.0005 to about 0.01. In other embodiments, the cured dielectric materials have a dielectric loss between 8.2 and 12.4 GHz of about 0.001 to about 0.005.

### Examples

Many techniques are available for the measurement of electric permittivity and loss tangent, including the transmission/reflection line (TRL) method, open-ended coaxial probe method, free space method, and the resonant method. For its combination of accuracy and practical use when taking broadband measurements of solid materials, the TRL method which uses a Keysight X11644 WR90 waveguide calibration kit, Keysight Materials Measurement software suite, and FieldFox N9918A Vector Network Analyzer (VNA) was selected. With the TRL method, two-port S-parameter measurements are taken, then the dielectric constant and loss tangent are extracted. The Keysight software suite enables the selection of the most accurate method for S-parameter conversion into complex permittivity values. Nicholson-Ross-Weir (NRW) method was chosen given its widespread use. The WR-90 waveguide characterization technique characterizes the dielectric constant and dielectric loss between 8.2 and 12.4 GHz. The inhibited polynorbornene ink as described herein was tested and compared to a commercially available dielectric ink, NEA121. NEA121 is a photocurable mixture of benzophenone, 1,3,5-triallyl-1,3,5-triazine-2,4,6(1H,3H,5H)-trione, and pentaerythritol tetrakis(3-mercaptopropionate). Both inks were poured into aluminum trays and placed on hot plates set to 60° C. to cure. The cured materials were removed from the hotplates after 6 hours, cut into rectangular structures, and characterized.

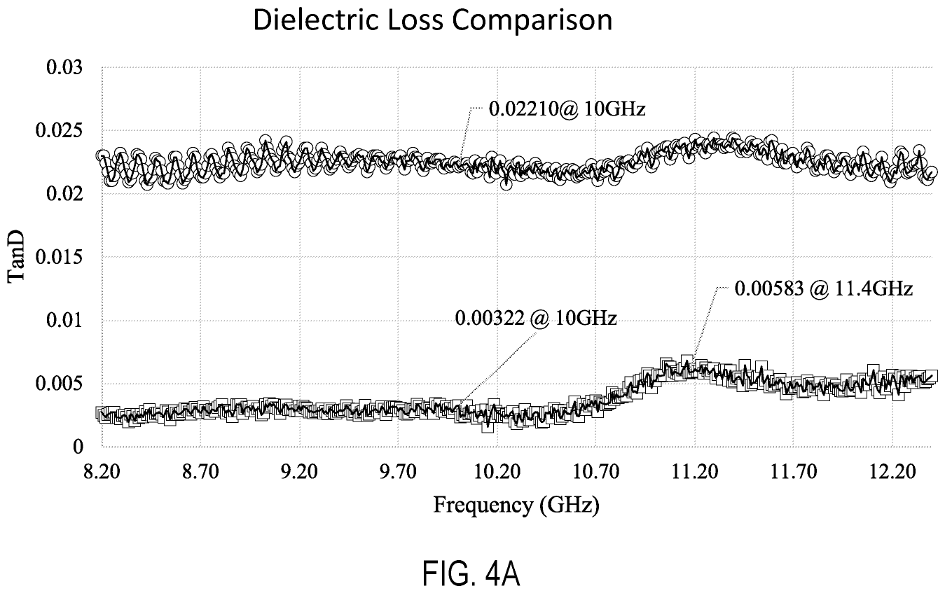

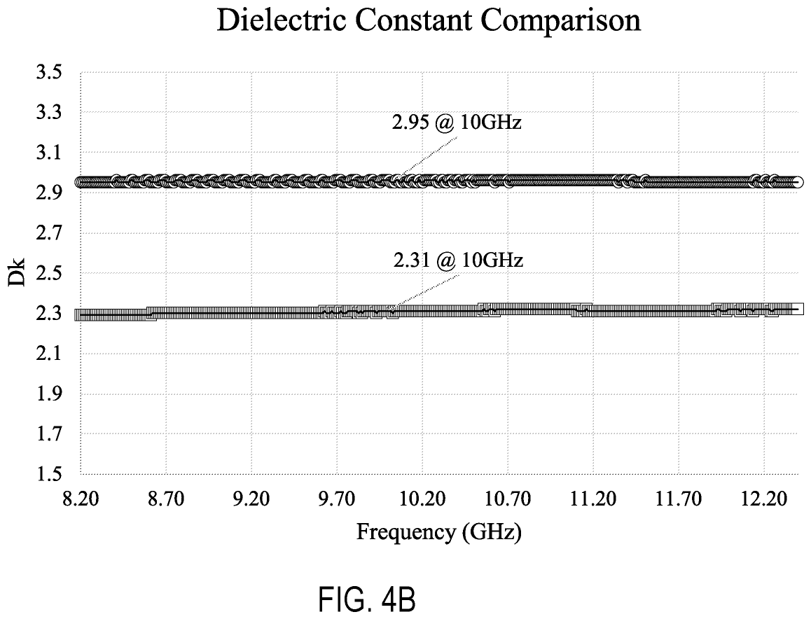

The inhibited polynorbornene ink demonstrated a dielectric loss of 0.00322 (FIG. 4A, bottom trace) and a dielectric constant of 2.31 at 10 GHz (FIG. 4B, bottom trace). The commercial ink NEA121 demonstrated a dielectric loss of 0.0221 (FIG. 4A, top trace) and dielectric constant of 2.95 at 10 GHz (FIG. 5B, top trace).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

What is claimed is:

1. A method of making the printable dielectric ink composition, the method comprising:
combining a monomer with catalyst for a period of time to form monomer-catalyst complex and initiate polymerization and form a catalyst-polymer complex;
adding an inhibitor to the catalyst-polymer complex to inhibit the catalyst and polymerization, and form an inhibited catalyst-polymer complex;
adding a crosslinker to the catalyst-polymer complex to form a printable composition; and
printing the printable composition, and optionally activating the crosslinker, to form a crosslinked material on a substrate.

2. The method of claim 1, further comprising adding an inhibitor to the catalyst-polymer complex to inhibit the catalyst and polymerization, and form an inhibited catalyst-polymer complex;
wherein the crosslinker is added to the inhibited catalyst-polymer complex.

3. The method of claim 1, wherein the crosslinker is activated by light having a wavelength of from 200 to 400 nanometers (nm).

4. The method of claim 3, wherein activation occurs with a photosensitizer to induce crosslinking in the polymer.

5. The method of claim 3, wherein the light is applied by a light source during or subsequent to being deposited onto a surface of a substrate.

6. The method of claim 5, wherein the light source includes light emitting diodes (LEDs).

7. The method of claim 1, wherein the crosslinker is activated by heat, and following addition of heat, the crosslinker induces crosslinking in the polymer.

8. The method of claim 7, wherein heat is applied by depositing the printable composition onto a heated substrate.

9. The method of claim 8, wherein a temperature of the heated substrate between 60 and 120 degrees Celsius.

10. The method of claim 9, further comprising performing a secondary heat treatment.

11. The method of claim 10, wherein the secondary heat treatment is performed at 140 degrees Celsius.

12. The method of claim 11, wherein the secondary heat treatment is performed for 8 hours.

13. A printable dielectric ink composition comprising:
a catalyst-polymer complex; and
a crosslinker;
wherein the printable dielectric ink composition has a viscosity of about 1 to about 10 centipoises (cP).

14. The ink composition of claim 13, wherein the catalyst-polymer complex includes a monomer.

15. The ink composition of claim 14, wherein a viscosity of the monomer is about 1 to about 10 centipoises (cP).

16. The ink composition of claim 14, wherein the monomer incudes a strained bicyclic carbon ring, with an unsaturated bond within the ring.

17. The ink composition of claim 14, wherein the monomer includes an alkene group.

18. The ink composition of claim 17, wherein the monomer includes 5-vinyl-2-norbornene.
